(19) United States
(12) Patent Application Publication
(10) Pub. No.: US 2003/0221381 A1
(43) Pub. Date: Dec. 4, 2003

(54) Exterior vision panel system

(76) Inventor: Raymond M.L. Ting, Pittsburg, PA (US)

Correspondence Address: RICHARD L. BYRNE, 700 KOPERS BLG, 436 SEVENTH AVENUE, PITTSBURGH, PA, 15219-1818, US

(21) Appl. No.: 10/158,689

(22) Filed: May 29, 2002

(51) Int. Cl. E06B 1/04; E04H 1/00

(52) U.S. Cl. 52/204.1; 52/235; 52/656.5

(57) ABSTRACT

In a preferred embodiment, a window perimeter frame and a window panel frame form a first exterior water flow-restrictor between the window perimeter frame and the window panel frame that forms an outer airloop that is maintained at the same pressure as the environment exterior to the building. A water restrictor and an air seal are provided between the airloop and the building interior such that the air seal does not have to cope with water from the exterior environment. Similar water restrictors and air seals are placed in between the window perimeter frame and building as well as between the window frame and window panel. A splined male member slidably placed in a female joint area attaches the perimeter frame to the window panel frame allowing relative displacement between the perimeter frame and panel frame member and installation of the frames from the interior of a building.

### CLAIM FOR PRIORITY, INCORPORATED BY REFERENCE

This application incorporates the disclosure in PCT patent application Ser. No. PCT/US00/28042, filed on Oct. 11, 2000, published on Nov. 1, 2001 and entitled Enhanced Window Frame Assembly and Method. The prior filed PCT Patent Application and any other documentation referenced therein and other documentation referenced herein are incorporated herein in their entirety by reference. If the descriptions and drawings in the prior filed PCT Patent Application and the other referenced documentation are inconsistent with the description and drawings herein, the description and drawings herein take precedence.

### FIELD OF THE INVENTION

This invention relates to an improvement on an isolated exterior panel, such as a vision panel commonly known as a window, window wall, punch-out windows, or ribbon windows or other non-curtain-wall panel systems. More specifically, the invention relates to an improved window frame assembly that seals against exterior water and air leaking into a building interior.

### BACKGROUND

Windows and other exterior panels generally allow outward vision from inside a building. However, because of glass or other typically brittle materials of construction, the panels are typically framed and the framed panels supported by other portions of the building. The framed panels may also provide other benefits such as improved aesthetic appearance. One type of exterior arrangement for a building is a curtain wall where exterior vision and/or other framed panels are each generally supported by an associated internal mullion or other interior building support structure, forming an essentially non-load bearing exterior surface of a building.

Another type of building exterior arrangement includes a wall or other exterior structure that supports, at least in part, adjacent windows or other panel systems that are separated or isolated by other portions of the wall, e.g., an isolated vision assembly or system comprising a series of fixed framed window panes placed on a spandrel sill in an exterior load bearing wall of a building. The windows or other panels may be fixed or openable and may also be placed in an exterior door or other adjacent exterior structures that generally support the isolated windows or panels. Exterior building structure such as wall typically comprise some type of masonry structure or mixed structure, e.g., precast concrete, bricks, hollow blocks, masonry, mortar, cement and stucco on a wood or steel stud frame, but other exterior building structures can be doors composed of wood, plastic, metal, or other structural material. Walls or other building exterior structures may be directly load bearing or otherwise supported, e.g., at each floor.

A window wall system normally refers to one type of an isolated vision or other panel assembly extending from a floor surface to a ceiling level between two partitioning vertical masonry walls or other exterior structure such as commonly seen on high-rise apartment building with extended exterior patios. A punch-out window system normally refers to a vision assembly formed within a punch-out area of a load-bearing masonry wall or wooden door. A ribbon window system normally refers to the condition of vision panels forming a horizontal band between two horizontal bands of masonry walls.

The three system types mentioned above and other wall/window systems can be classified as isolated exterior windows or other framed panels in a building wall that provides at least a significant portion of the support for the framed panels. An isolated vision or other panel system is differentiated from a curtain wall panel system where the majority of support for each exterior panel is not provided by an exterior wall structure.

The cost of installing, maintaining, and replacing prior-art isolated windows in a large commercial building is not insignificant. Costs can result from the need to install fixed windows from outside the building, time consuming and costly sealing of window panels in the field, and providing cleaning, repair, maintenance, and other access to the fixed windows, especially access to the exterior surface of the window and/or window frame.

And despite the high installation and maintenance costs, prior isolated or framed window panel systems may still allow excessive air and/or rain water to get into the building, e.g., after seal degradation, under extreme wind conditions, or under extreme structural loadings due to single-events such as seismic events. In addition, inter-floor deflection, dynamic cycles of positive and negative wind loads (e.g., winds and/or wind loads directed towards and away from the building interior on one side of the building), daily thermal expansion and contraction, and other daily ventilation and other equipment operation may cause loosening of building attachment means, structural fatigue failures, and hysteresis loss of seal compression, resulting in still further damage and water leakage.

A significant problem of many exterior vision panel systems is water leakage along the panel, frame, and wall interface areas, especially after time and exposure to various environments/structural loads cause deflection and cracks in seals and/or in masonry walls or wood doors. For example, inter-floor deflection, seismic and other loads that are not sufficient to cause direct failure, may still tend to crack or loosen window panes and damage window seals, especially if the windows are improperly installed or the building structure is slightly deformed. Moreover, repairs may require access from outside the building to accomplish field caulking to resist water and exterior air infiltration (requiring exterior access equipment for upper floor windows) and air and water leakage repair is often temporary in nature and may require repeated repairs. Thus, although significant advancements have been made in achieving some objectives for a window frame or other isolated panel systems, an improved system is still needed.

### SUMMARY OF THE INVENTION

A preferred embodiment of a panel frame assembly for supporting an exterior panel assembly is attached to at least two exterior building surfaces, the panel frame assembly comprising at least one window frame element sealably connected to a panel forming a framed window subassembly and at least two perimeter frame elements each secured to a building surfaces and each sealably connected to the framed window subassembly with an air seal and a water restrictor. The frames, building surfaces and panel forms at least two airloops and an air space, each having an air seal, a water restrictor and an air passageway for substantially equalizing air pressure within the airloop or air space and the air pressure in the exterior environment. In the preferred embodiment, the cross-sectional area of the air passageways is at least about 0.1 square inches. The embodiment is similar to the airloop system described for a curtain wall assembly in U.S. Pat. No. 5,452,552, but the window perimeter frame, building surfaces, a perimeter air seal, and a perimeter water restrictor form an air space that is pressure equalized through an air passageway. The airloops and air space act to further limit any water transmission from the water restrictor so that the air seals do not have to contend with significant amounts of water. The airloops and air space also include means for draining any water that may be leaked or condensed therein before most of the water can contact the air seals. The airloops, air space, water restrictors, and spaced-apart air seals provide a long term reduction in water leakage problems even after seals become imperfect. Still further, the adverse impacts of relative vertical deflection/displacement between perimeter and panel frames are minimized by a splined male member slidably placed in a female joint area that allows relative displacement between the perimeter frame and panel frame member without the loss of the water restrictor or air seal functions still further reducing long term water leakage problems. Moreover, the preferred embodiment uses slidable clips and splines, allowing installation of the window frame without access from a location exterior to the building. The design also uses compatible panels for adjoining curtain wall or similar windows to minimize interface problems.

Embodiments of the isolated or framed panel assembly may also include some or all of the following features: an air passageway sufficient in size to equalize the pressure in an air loop with the exterior environment and drain the airloop and incorporate baffles or protrusion to create a circuitous path water restrictor to limit water entry, structural retention of a framed window subassembly within a secured frame element for sealing and resisting positive (inward directed) and negative (outward directed) wind loads, thermal breaks in one or more frame elements to increase the resistance to heat transfer between the building interior and the exterior environment, and cover frame elements to allow easier window assembly installation and removal but limit unintentional removal.

### BRIEF DESCRIPTION OF THE DRAWINGS

FIG. 1 is a fragmented partial exterior elevation view of a typical airloop exterior-vision panel system of the invention having a single punch-out window panel.

FIG. 2 is a fragmented partial exterior elevation view of a typical airloop exterior vision panel system of the invention having multiple punch-out window panels or having a window wall system.

FIG. 3 is a fragmented partial exterior elevation view of a typical airloop exterior-vision panel system of the invention having a ribbon window system.

FIG. 4 is a partial cross-sectional view taken along line 4-4 of FIG. 1 or FIG. 2 or FIG. 3.

FIG. 4a is a partial cross-sectional view similar to FIG. 4, but of an alternative spandrel veneer system embodiment.

FIG. 5 is a partial cross-sectional view taken along line 5-5 of FIG. 1 or FIG. 2 or FIG. 3.

FIG. 6 is a partial cross-sectional view taken along line 6-6 of FIG. 1.

FIG. 7 is a partial cross-sectional view taken along line 7-7 of FIG. 2 or FIG. 3.

FIG. 8 is a partial cross-sectional view taken along line 8-8 of FIG. 2.

FIG. 9 is an isometric view of the perimeter frames before assembling.

FIG. 10 is an isometric view of the positioning clip for assembling the perimeter frames.

FIGS. 11a-d shows air seal corner connections.

In these Figures, it is to be understood that like reference numerals and/or letters refer to like elements or features with similar functions.

Description

In order to better explain the working principles of the invention, the following terminology will be used herein:

a window or other panel: a glass or other essentially non-load supporting wall element secured and nominally sealed to a window or panel frame;

an inner airloop: an air space substantially forming a loop around and near the perimeter edges of the glass or other panel element and generally within the window frame or panel frame;

an outer airloop: an air space substantially forming a loop around the window pane or panel proximate to the inner air loop;

a perimeter air space—an air space between a field installed perimeter frame and an adjacent building surface, e.g., cut-out surfaces for an isolated window in a masonry wall;

a water seal: a sealant line in an exterior water path towards an interior space within the building, the water seal restricting water infiltration when little or no differential air pressure is present across the sealant line;

a water restrictor: a water seal or other means to minimize water transmission in an exterior water path towards an interior space such as a tortuous path tending to remove water droplets from air passing through; and

an air seal: a sealant line for restricting exterior air infiltration into the building located inboard and spaced-apart from a water seal or other water restrictor.

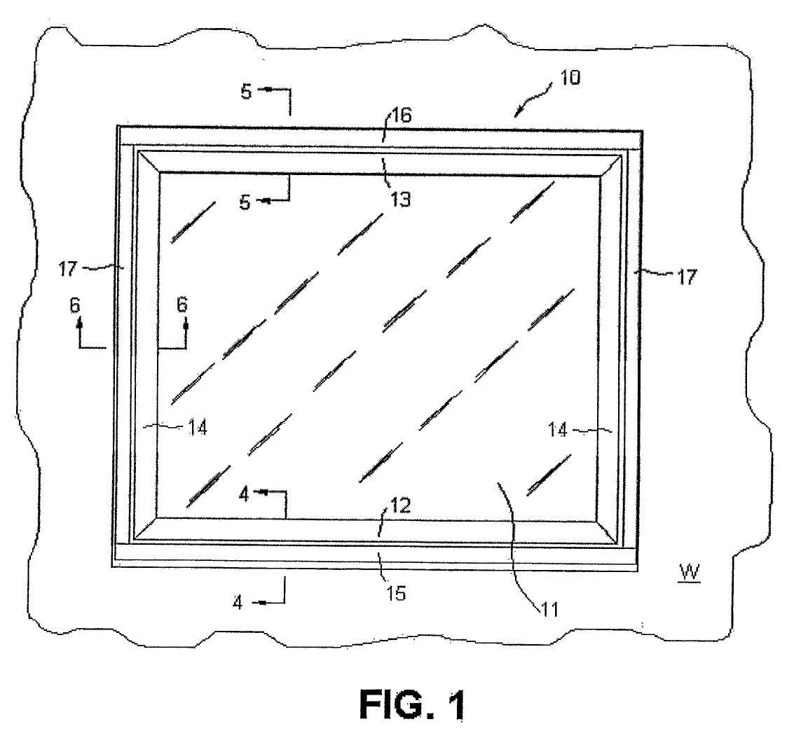

FIG. 1 illustrates an embodiment of an airloop exterior vision panel system 10 of the punch-out window type comprising a single glass panel 11 with shop installed sill panel frame 12, head panel frame 13, and two jamb panel frames 14 and four field installed perimeter frames: sill frame 15, head frame 16, and two jamb frames 17. Although the frames are composed of an extruded aluminum alloy in the preferred embodiment, other materials of construction may be used in alternative embodiments such as extruded steel, PVC or other relatively rigid plastics.

The punch-out window system shown supports a double-pane window panel 11, which in turn is supported by the masonry wall or stud wall W. In alternative embodiments, the panel 11 may also have metal, plastic, or other connected decorative jamb elements (e.g., forming what appears to be a two or four glass panel system), be composed of a plastic material, a photovoltaic material, or other panel materials instead of glass. In still other alternative embodiments, the window panel 11 may be composed of a single glass panel, a composite material panel, or other types of window-like panels. In still other alternative embodiments, the exterior vision panel system is located in exterior building surfaces other than exterior masonry walls such as a skylight in a roof structure or a window in an exterior door.

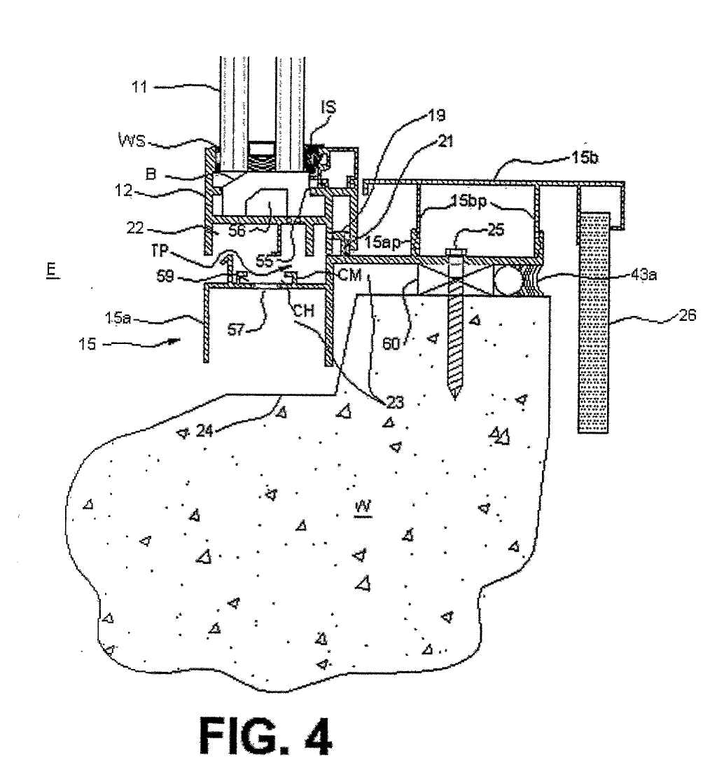

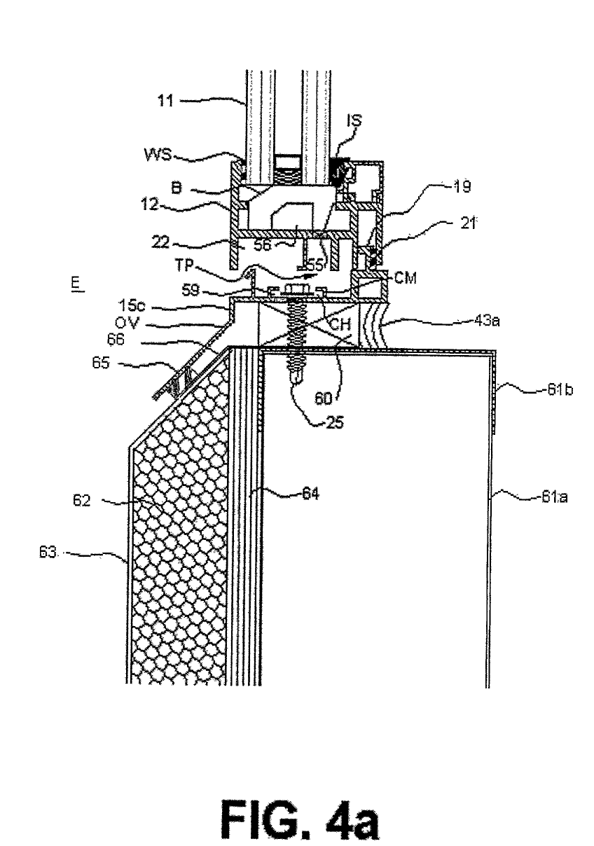

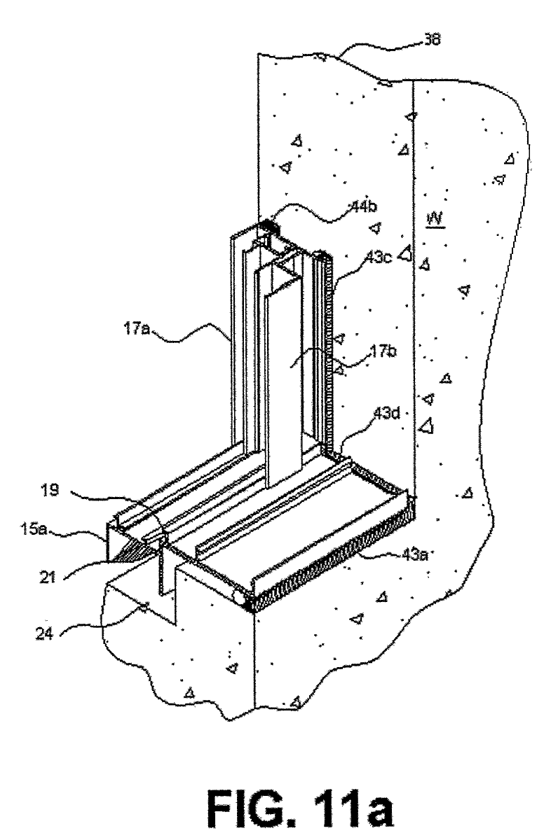

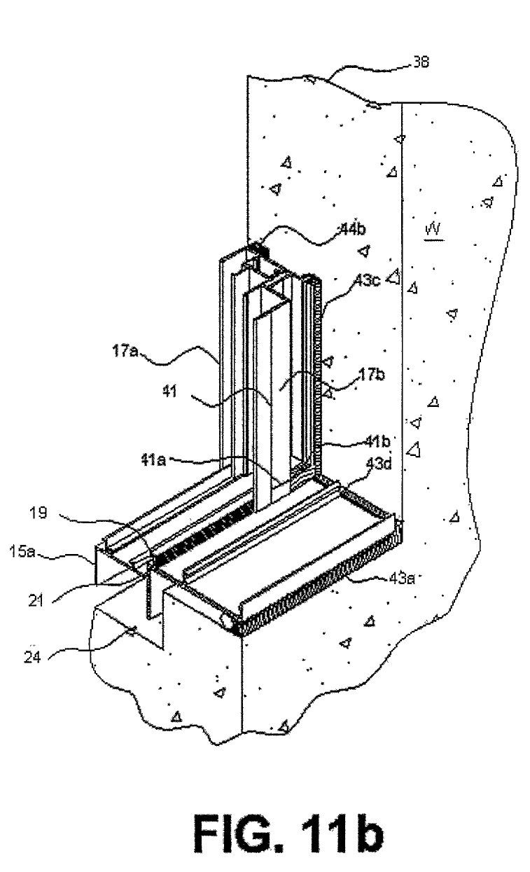

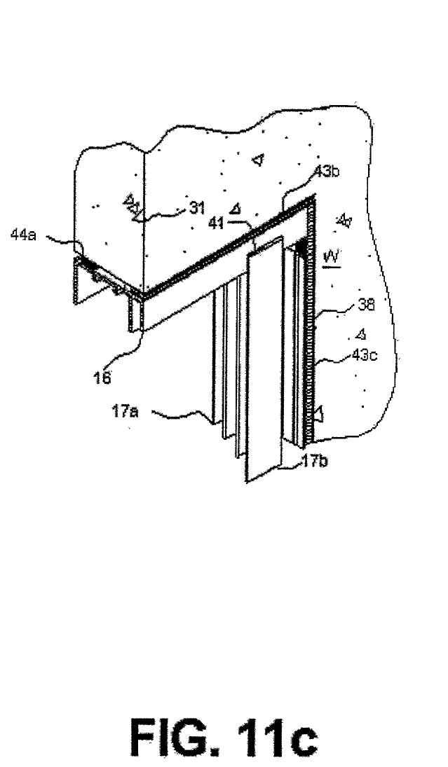

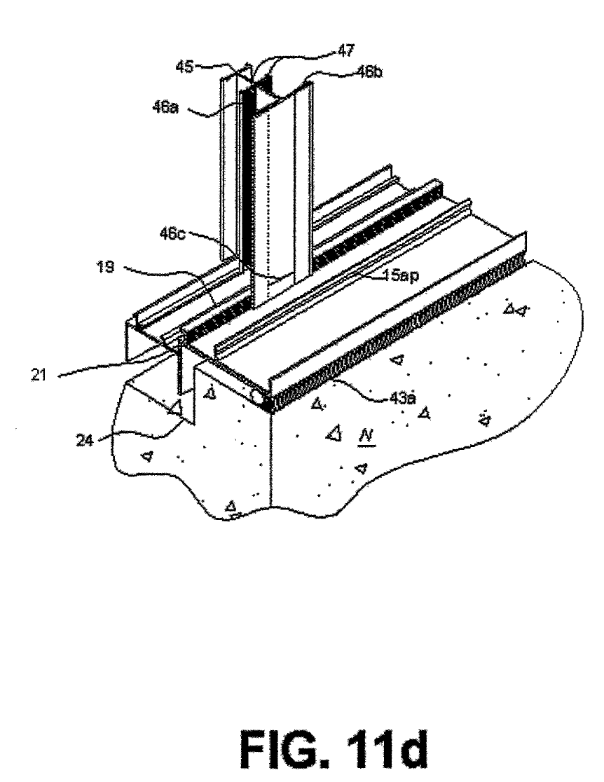

FIG. 1 shows mitered corners on the various frame members. As discussed below and shown in FIGS. 11a through 11d, the corners of the frames may also connect air seal such that air spaces or airloops may allow air and/or water to flow around the perimeter of the window panel 11 without penetrating the building interior I. (See FIG. 4 for building interior, air loops, and air spaces. See FIGS. 11a-11d for a preferred seal embodiment at the corners.) If corner-connected, the airloops and air spaces may allow water to drain from upper airloop portions to one or more drain holes in lower airloop portions, e.g., as shown on FIG. 4. If the airloops or air spaces are not corner connected, each segment or portion may include an air passageway to equalize air pressure and/or drain water.

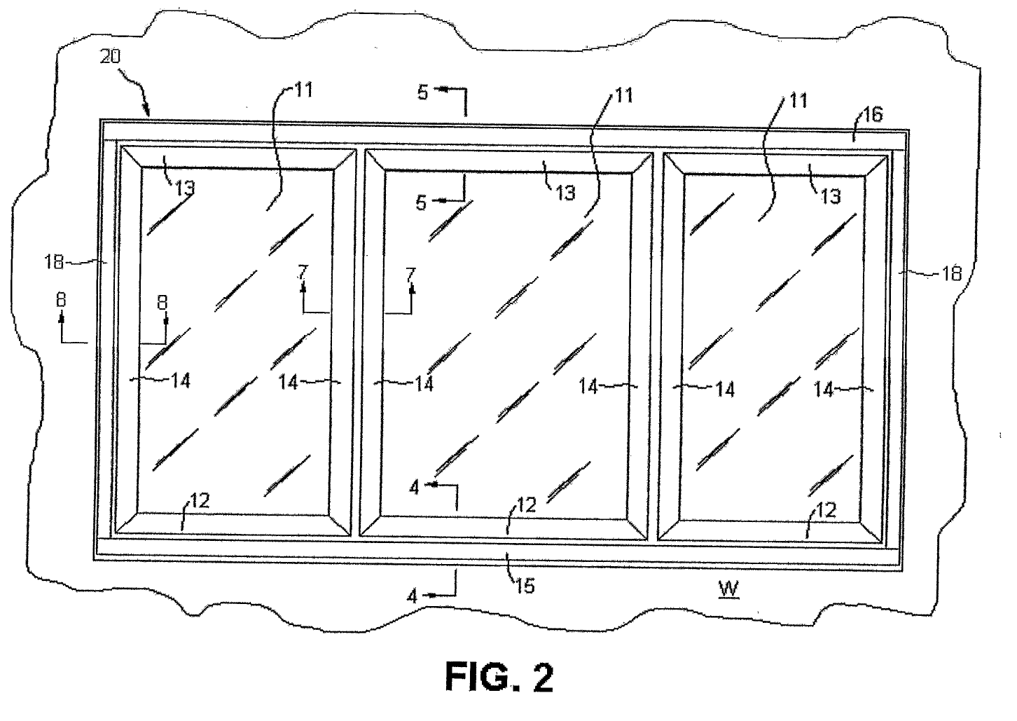

FIG. 2 illustrates an embodiment of the airloop exterior vision panel system 20 of the window wall type comprising multiple vision glass panels 11, each with shop installed sill panel frame 12, head panel frame 13, and two jamb panel frames 14, all sealably connected to the perimeter frames. Four perimeter frames are typically field installed to form a perimeter frame assembly: a sill frame 15, a head frame 16, and two jamb frames 18. The window wall system 20 is supported by the masonry wall W. Similar to the punch out window system described above, alternative materials and designs may be used for the glass panels 11 in alternative embodiments. In addition to the fixed window panel shown in FIG. 2, double-hung windows, casement or other types of panels or windows may be incorporated in alternative embodiments.

FIG. 2 also shows mitered frame corners. Similar to the above discussion and as discussed below and shown in FIGS. 11a, 11b, 11c, and 11d, the mitered corners may also provide additional corner seals and fluid pathways for various airloops and air spaces that extend around the perimeter of the window wall system.

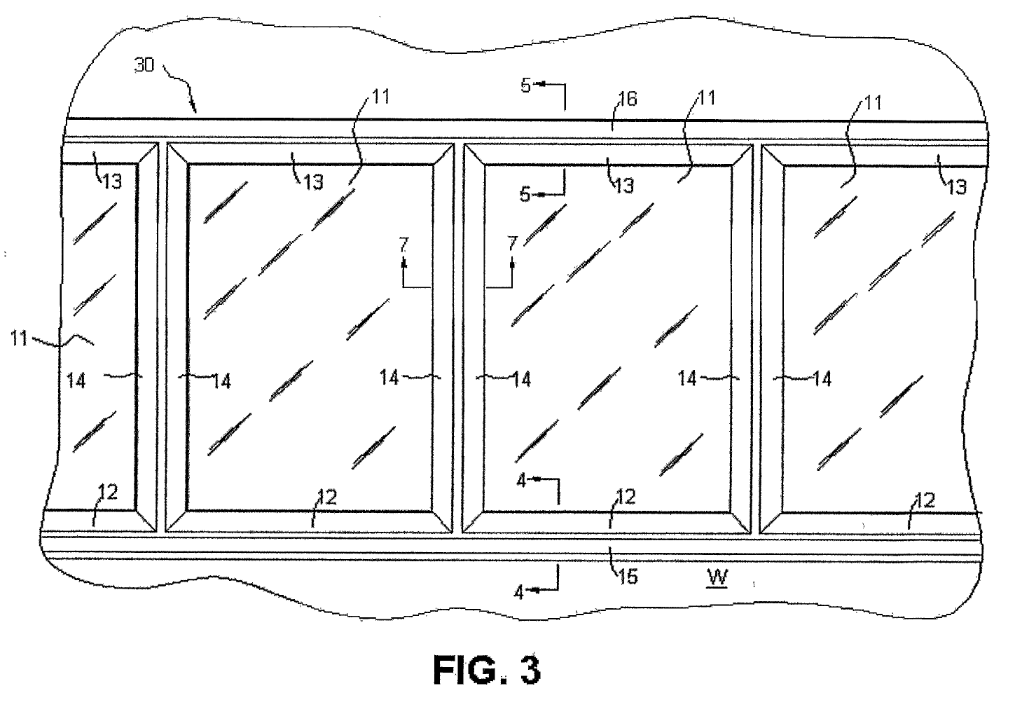

FIG. 3 illustrates an embodiment of the airloop exterior vision panel system 30 of the ribbon window type comprising multiple vision glass panels 11, each with a shop installed sill panel frame 12, head panel frame 13, two jamb panel frames 14 and connected to two perimeter frames that are typically field installed: sill frame 15 and head frame 16. The ribbon window is supported by a masonry or stud wall W. In alternative embodiments, the ribbon window may include patio or other doors, casement or other openable windows, and have other variations similar to that described above.

FIG. 3 also shows mitered corners. Similar to the above discussion and as discussed below, the mitered corners may provide air and/or water drainage pathways for various airloops that extend around the perimeter of the ribbon wall system.

FIG. 4 shows a typical fragmentary cross-section of one embodiment of the perimeter sill condition taken along line 4-4 of FIG. 1 or FIG. 2 or FIG. 3. The perimeter sill frame 15 is typically field installed and comprises an open and/or cantilevered structural perimeter sill member 15a and an interior sill cover 15b. The perimeter sill member 15a is supported by a masonry wall W. In alternative embodiments, the structural perimeter sill member 15a may be supported by a window spandrel beam or other structural member which is in turn supported by an alternative wall, door, or other support structure. In addition, flashing, insulation, sealing, or other interface materials may be placed in between the cantilevered sill member 15a and wall W.

Wall W preferably includes a recessed edge 24. Although the depth of the recessed edge 24 (from the wall surface where a first fastener 25 attaches the perimeter sill member 15a to the wall W) can vary, the depth is preferably at least about ⅛ inch (0.32 cm), more preferably at least about ¼× inch (0.63 cm), and most preferably at least about ½ inch (1.27 cm). If the outboard edge of wall W is also downwardly sloped outward as shown, the depth of the sloped portion at the exterior edge of the wall W (also from the wall surface where the first fastener 25 attaches the perimeter sill member 15a to the wall W) is at least about ¼ inch (0.63 cm), more preferably at least about ½ inch (1.27 cm), and most preferably at least about 1 inch (2.54 cm)

Cover projections 15bp of the interior sill cover 15b are preferably snap fit with sill member projections 15ap. However, in alternative embodiments, other means for attaching the interior sill cover 15b to the sill member 15a may be used, e.g., screws, clamps, adhesives, latches, openable hinges, or other fasteners.

The design of the sill frame member 15a and a lower panel-to-perimeter interface frame or sill frame 12 produces two unsealed openings to a perimeter air space 23 and an outer airloop 22. The unsealed openings allow air from the exterior environment E to enter and equalize pressure on both sides of one or more drainage holes 57. However, the path of any air flow into the interior portion of the perimeter air space 23 or outer airloop 22 is tortuous to act as a water restrictor and/or water removal device from the air moving towards the interior environment I. Although the dimensional size of the perimeter air space 23 can vary widely, an excessively small size can result in interference and tolerance problems between the perimeter sill frame 15a and wall W, especially if deflections of the wall are encountered. However, an excessively large opening and cross-sectional dimensions of the perimeter air space 23 (and outer airloop 22) can result in a less tortuous path and water penetration deep inside the perimeter air space. In the preferred embodiment, a nominal distance between any surface of the perimeter sill member 15a and the masonry sill edge 24 (outward of the drainage hole 57 and outward of the first attachment means and attachment shim 60) ranges from at least about 0.01 inch (0.025 cm) to no more than about 1 inch (2.5 cm) or more, more preferably from at least about 0.1 inch (0.25 cm) to no more than about 0.5 inch (1.25 cm), and still more preferably from at least about 0.125 inch (0.32 cm) to no more than about 0.375 inch (0.96 cm).

The bottom segment of an outer open airloop 22 is formed between the perimeter sill member 15a and the interface or panel sill frame 12 forming a water restrictor, in this case a tortuous air path from the external environment E to air hole 55 as shown by arrow path TP. The tortuous path TP is similar in function to the recessed water path in the perimeter air space 23. The tortuous path TP within a portion of the outer airloop 22 tends to remove water droplets for air moving towards the building interior I prior to any air entering the air hole 55 or contact with air seal 21. Water removed from the outer airloop 22 is drained through drain hole 57 into the lower air space portion 23 to be drain to the exterior of the wall W.

The lower air space portion 23 shown is also pressure equalized to the exterior E through the passageway between the wall W and the outer portion of the perimeter sill frame 15a. The perimeter sill member 15a is structurally secured to the masonry edge preferably using at least two first-fasteners 25. The male spline 19 (when combined with an air seal 21) is designed to cause the structural engagement of the perimeter sill member 15a with the interface frame (or panel sill frame) 12. The interface or panel sill frame 12 has one or more air holes 55 allowing pressure equalization of the inner airloop 56 from the pressure equalized, lower air space portion 23.

The interior cover 15b is designed to provide an interior sill finish. In the embodiment shown in FIG. 4, the interior cover 15b also covers the top edge of an interior wall 26, but other embodiments may not include an interior wall.

The perimeter air seal 43a is formed between the structural sill member 15a and the masonry sill edge 24 preferably using curable caulking, however other sealing materials may be used in alternative embodiments. One or more drainage holes 57 are provided in the perimeter sill member 15a, e.g., below the center of the punch out window panel 11 shown in FIG. 1.

Besides the snap fit connection embodiment shown, various shapes and means for connecting the perimeter sill member 15a and the interior sill cover 15b can be contemplated, for example, a sill cover and perimeter sill member screw connection, hinged connection, and a slotted connection. However, essentially all of the alternative shapes of a perimeter sill member 15a provide a water restrictor between the wall and perimeter sill member, such as an elastomeric water seal or the tortuous path for entering air shown. In other embodiments, a screen or other water contacting device can replace or supplement the tortuous path or be placed over the drain hole 57.

The dimensioning of the drainage hole 57 may vary widely, e.g., depending upon the wind and rain loads expected to enter the outer airloop 22, along with channel members CM to provide a channel CH between drainage holes to direct collected water between drainage holes 57 to a proximate drainage hole. However, the drainage holes 57 should not be too large so as to allow substantial amounts of water-laden air to flow from the outer portions of the perimeter air space 23 to the outer airloop 22. For a nominal punch out window, at least one drainage hole 57 preferably has a cross sectional area of at least about 0.01 square inches (0.064 sq. cm), e.g., at least a nominal ⅛ inch (0.32 cm) diameter hole is preferred. However, other applications may require multiple drainage holes with larger or smaller dimensions, more preferably at least about two drainage holes located at or near the center and each having an opening of at least about 0.196 square inches (1.267 square centimeters), e.g., a nominal ½ inch (1.27 cm) diameter drainage hole.

The one or more air holes 55 are also sized to drain leaked or condensed water (e.g., leaking water from one or more water seals WS) as well as to simultaneously pressure equalize the inner airloop 56, e.g., allowing water to drain down while also allowing exterior air to flow up. This can be accomplished by having more than one air hole 55 at different locations (for example, near one or more corners) and sizes, e.g., larger to allow water and air flows. However, the size of each air holes 55 is preferably similar to the preferred drainage hole 57 discussed above.

The dimensions of the tortuous path TP of the outer airloop 22 are also limited in order to minimize water droplet carryover. The tortuous path TP does not allow a straight path flow of air from the exterior environment E to enter the air hole 55. Preferably, the tortuous path consists of at least two baffles with one located on the sill member 15a and one located on the panel sill frame 12. The air flow cross-sectional area through the tortuous path is typically sized to be at least double the cross-sectional area of the air hole 55, but also requiring the air flow from the exterior environment E to turn and change direction at least once. Similar to the above discussed spacing between the perimeter sill member 15a and sill surface 24 of wall W, the closest any portion of the perimeter sill member 15a approaches the lower interface frame (or panel sill frame) 12 outboard of the air hole 56 is preferably at least about from at least about 0.01 inch (0.025 cm) to no more than about 1 inch (2.5 cm) or more, more preferably from at least about 0.1 inch (0.25 cm) to no more than about 0.5 inch (1.25 cm), and still more preferably from at least about 0.125 inch (0.32 cm) to no more than about 0.375 inch (0.96 cm). In alternative embodiments, a water seal may take the place of the tortuous path TP.

The dual glass panel 11 is supported by one or more setting blocks B that, in turn, are supported by the panel sill frame 12. If a single block B is used, it is preferably discontinuous to allow a path for any water leaking past the window water seal WS to drain at one or more air holes 55. The pressure equalization of the inner airloop 56 with the external environment E minimizes water leakage past the window water seal WS even when the window water seal in imperfect, e.g., the window water seal is cracked due to aging and/or stress and acts as a tortuous path water restrictor.

The removal of leaking water through the air hole 55 and drainage hole 57 allows the interior window seal IS to restrict exterior air infiltration (or loss of interior air to the exterior environment) without the need to also seal against water leakage at this point. Any pressure difference between the interior I and exterior E environments will tend to leak air across the interior window seal IS, but not water since water contact with the air seal has been substantially precluded by the air holes, drains, water seals, and/or water restrictors. This exclusion of water tends to prevent corrosion, erosion, and further deterioration of interior portions of the panel or window system and interior window seal IS, improving long term performance. Because water is effectively excluded from contacting the window air seal IS, many types of air seals can be used that might otherwise be degraded by contact with water.

The mitered corners of the frame members shown in FIGS. 1-3 produce inner and outer airloop segments (e.g., having lower airloop segment 22 and 56 shown in FIG. 4) and a perimeter air space segments (e.g., the lower airspace segment 23 shown in FIG. 4) that together with other segments may extend around the perimeter of the window assembly. (See also FIGS. 11a-11d.) However, the inner and outer airloops e.g., see lower airloops 56 and 22 in FIG. 4) and the perimeter airspace segments 23 may not extend around the perimeter in some alternative embodiments. For example, flashing may be used to cover other portions of the frame to wall interfaces and avoid the need for a substantial perimeter airspace and restrict water transmission around the entire perimeter of the window system without a water restrictor. Other reasons for airloops or an airspace that does not extend around the entire perimeter of the window system include separate airloops and drainage paths around each side, support interfaces preventing airloop continuation, and an open interior space I not requiring air or water sealing.

The first fastener 25 is preferably a removable masonry screw securing perimeter sill member 15 to spacer 60a and wall W. In alternative embodiments, other means for spacing and fastening a frame element to a building wall W may be used, e.g., anchor bolts.

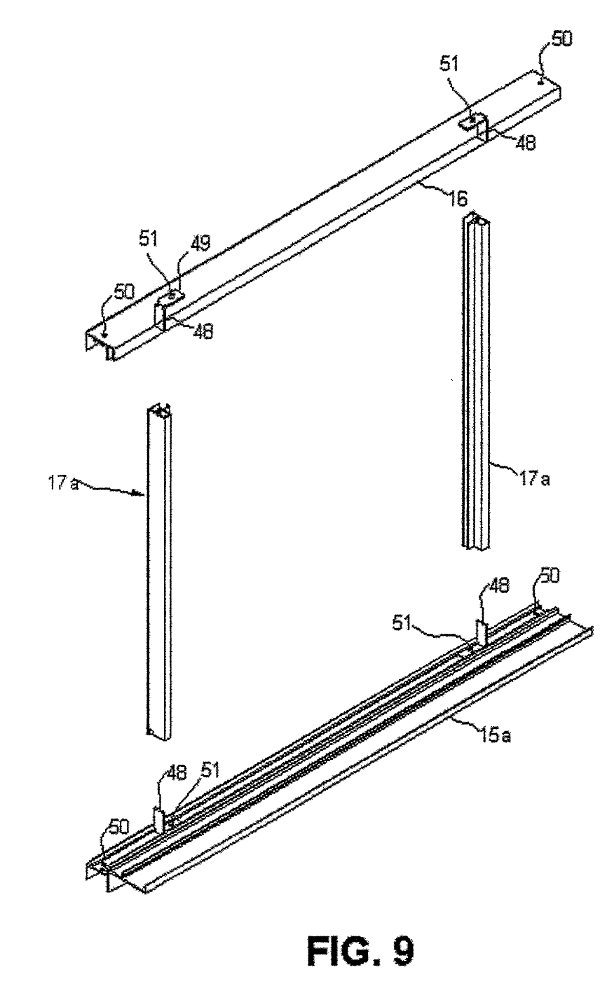

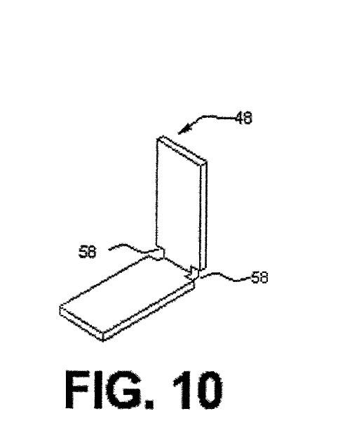

Protrusions CM in the perimeter sill frame 15 form a portion of a channel CH for slidably retaining the clip 48 (see FIGS. 9 & 10). The channel CH preferably slidably mates with clip 48 (as shown in FIGS. 9 and 10) across the entire length of the frame element 15a, but sliding may also be limited to an area near the ends of the frame element. The protrusions CM may also serve as baffles or additional tortuous path surface area acting as a water restrictor. In an alternative embodiment, the protrusions CM may be extended upwardly into the tortuous path to replace one of the baffles shown.

FIG. 4a is a cross-sectional view similar to FIG. 4, but of an alternative embodiment that uses a spandrel veneer system instead of a masonry wall. This type of spandrel veneer system typically includes spaced apart vertical stud members 61a (generally composed of steel), stud track member 61b structural face 64, insulating foam board 62, and a water-resistant protective skin 63. A flushing plate 66 (generally composed of aluminum) is attached (generally with glue or other adhesive) to the top surface of the spandrel veneer system to form a drainage surface. In comparison to FIG. 4, the structural perimeter sill member 15a is replaced with an alternative perimeter sill member 15c in FIG. 4a and the water restrictor path shown in FIG. 4 is replaced with a water seal 65, generally a shop installed foam tape. The water seal 65 is preferably not continuous, but leaves a small gap of at least about 0.1 inch (0.25 cm) near the center for water drainage, more preferably the gap is about 1 inch or 2.5 cm. The discontinuous water seal 65 plus the overhang OV of the alternative sill member 15c acts as a tortuous path and water restrictor in the air space between the sell member 15c and spandrel veneer system wall, substantially allowing air to equalize in pressure to the exterior environment but preventing water droplets from being transmitted past the discontinuous water seal 65. The overhang OV is preferably at least about 1 inch (2.5 cm), more preferably at least about 2 inches (5.1 cm) in order to limit water entry past the discontinuous water seal 65. Other portions of the alternative embodiment for a spandrel veneer sill, including the lower interface frame 12, are similar to that shown for a masonry wall in FIG. 4.

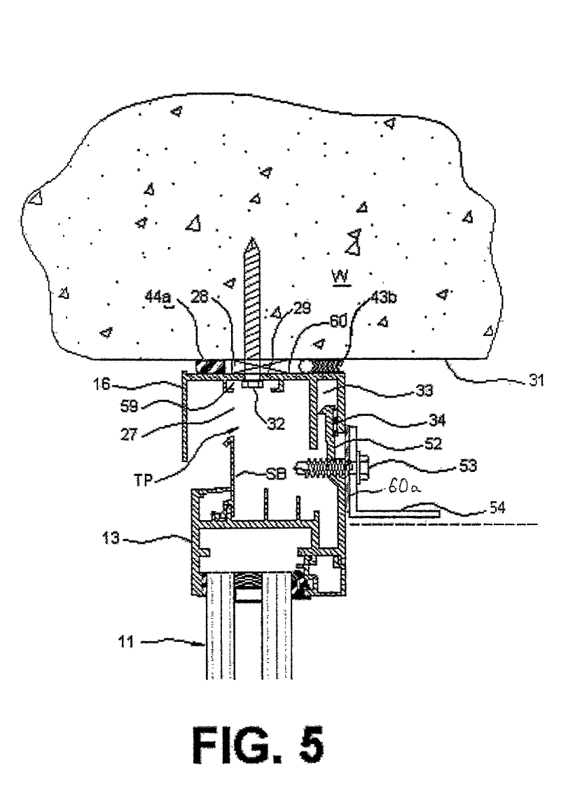

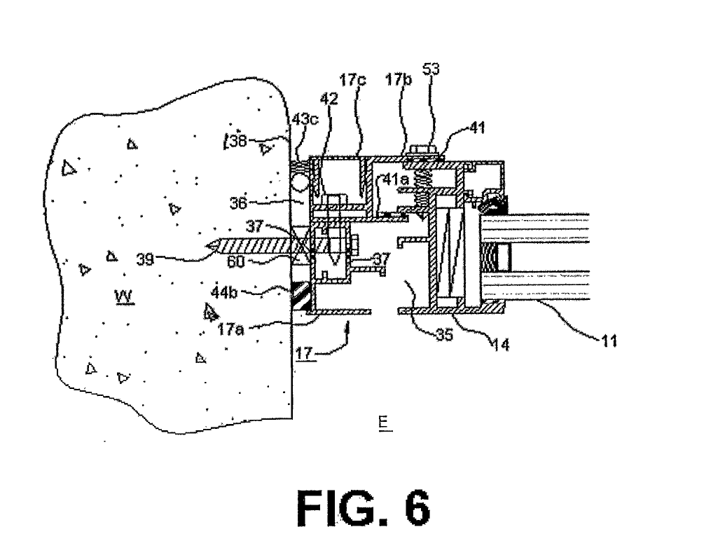

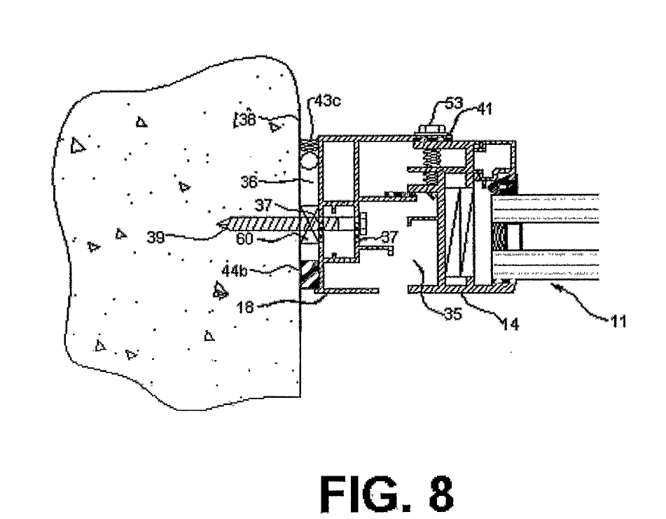

FIG. 5 shows a typical fragmentary cross-section of one embodiment of the perimeter head portion taken along line 5-5 of FIG. 1 or FIG. 2 or FIG. 3. The top segment of an upper outer airloop 27 is formed between the perimeter head member 16 and the window panel head frame 13. As discussed elsewhere herein and shown in FIGS. 11a-11d, the mitered corner joints may fluidly connect the upper outer airloop 27 to the lower outer airloop 22. Preferably, the upper perimeter air space 28, the lower perimeter air space 23 (shown on FIG. 4), and the side perimeter air space 36 (shown on FIGS. 6 and 8) are each independently pressure equalized with air holes or openings. The upper perimeter air space 28 is formed between the perimeter head member 16 and a masonry head edge 31 of the building wall W. The perimeter head member 16 is structurally secured to the masonry edge 31 preferably using at least two second fasteners 32. The first and second fasteners are preferably similar, but other means for fastening as discussed above may also be used.

The perimeter head member 16 has a female joint and seal space 33 to engage the panel head frame 13, spline 52 and air seal 34. The panel head frame 13 is held in the engaged position by male joint spline 52 and third fastener 53 that is attached to the ceiling edge supporting angle 54 using a third fastener 53 and ceiling angle shim or spacer 60a. (Attachment of ceiling edge supporting angle 54 to ceiling or other building support is not shown for clarity.) The spline 52 and third fastener 53 allow the installation and removal of the panel assembly from the building interior without requiring exterior access. In alternative embodiments, other means for connecting and attaching (as discussed above) and other sealing engagements may be used, e.g., retained 0-rings and slidable gasketed joints.

The slidable seal 34 and female joint/seal space 33 configuration allows relative motion between the perimeter frame 16 and the panel head frame 13. Relative motion may be caused by deflections of portions of some wall structures, e.g., under variations in live loads in adjacent floor, the distance between opposing window cutout surfaces supporting a perimeter frame segment may vary. However, this type of supporting wall surface deflection motion is typically limited by the structural stiffness of the building structure. Under a maximum design live load on a floor, the deflections are typically about ⅜ inch (0.95 cm), at least about ¼ inch (0.64 cm) and no more than about 0.5 inches (1.27 cm). For preferred spline 52 and spline penetration into the depth D of the female joint and seal space 33, the depth is typically at least about at least about ⅜ inch (0.95 cm) and still more typically at least about ½ inch (1.27 cm). In alternative configurations, the slidable seal 34 may be configured as a lubricated gasket, O-ring, or other type of seal that will accommodate these relative motions between sealing surfaces of the panel head frame 13 and spline 52.

The upper outer airloop portion 27 includes snap-on impinging baffle SB within the airloop to form another tortuous path as shown by arrow TP and similar in function and design to the prior described tortuous paths TP (see, e.g., FIG. 4). The water impinging upon the exterior surface of snap-on baffle SB drains back towards the exterior environment. Water otherwise removed in the upper outer airloop 27 may also drain to one or more mitered corners and from there to other portions of the outer airloop until the water is drained to the exterior building wall surface, e.g., from drainage hole 57 as shown in FIG. 4. Since the fastener 53 is applied from the inside, the baffle SB can be made as an integral part of the head panel frame 13 in an alternative embodiment. The shape of the upper outer airloop portion 27 can vary widely, but the TP air passageway has functions similar to the pressure equalization and water restrictor functions of the lower outer portion 22 described above.

The upper perimeter air seal 43b, upper perimeter water seal 44a, portions of perimeter head frame 16 and portions of the masonry edge 31 form the other boundaries of the upper perimeter air space 28. The upper perimeter air seal 43b preferably uses field installed curable caulking and the perimeter water seal 44a preferably uses a foam tape shop installed on the perimeter head frame 16, however, other sealing methods and/or materials can be used in alternative embodiments, e.g., o-rings, C-type seals, and gaskets. To drain condensed or leaked water and/or to pressure equalize the upper perimeter air space 28, one or more air holes 29 are provided at locations preferably spaced apart from the fasteners 32. Various shapes for the perimeter head member 16 and various connection methods can be contemplated, e.g., protrusions and/or alternative shapes that form an alternative tortuous path TP replacing the upper perimeter water seal 44a.

FIG. 6 shows a typical fragmentary cross-section of one embodiment of the perimeter jamb frame 17 taken along line 6-6 of FIG. 1. The perimeter jamb frame 17 is preferably field installed and comprises a structural perimeter jamb member 17a, a jamb air cover member 17b, and an interior jamb cover 17c. The perimeter jamb frame 17 is attached to the perimeter head member 16 and the perimeter sill member 15 to form a continuous or discontinuous panel outer airloop and/or perimeter air space segments.

The side portion or segment of the outer airloop 35 is formed between the perimeter jamb member 17a and the panel jamb frame 14. Baffles or other protrusions into the outer airloop side portion 35 again provide a tortuous air path similar to the tortuous air paths described for other portions of the outer airloop. A side perimeter air space portion 36 is formed between the jamb members 17a & 17b and the masonry jamb edge 38 of the wall W. The side perimeter air space portion 36 is pressure equalized to the exterior environment E preferably through one or more air holes 37 typically spaced apart from the locations of the side fasteners 39. In other embodiments, the air holes 37 are not needed if protrusions or wipers form a water restrictor replace the water seal 44b and/or access to exterior air from a different perimeter segment is available at the frame corners.

The perimeter jamb member 17a is structurally secured to the masonry edge 38 of wall W using one or more side fasteners 39 spaced apart from the wall W by one or more shims or spacers 60. Although the preferred side shims or spacers 60 and side fasteners 39 are similar to the top and side fasteners previously discussed, alternative fasteners, shims, and spacers as previously discussed may also be used.

The jamb air cover member 17b and air seal 41a are structurally secured to the jamb member 17a using air cover fastener 42 which is accessible from the building interior I before the installation of the snap-on interior cover 17c. The side segment of the outer airloop 35 is formed between the perimeter jamb member 17a and the panel jamb frame 14 with a tortuous path shape similar to the other portions of the outer airloop. A perimeter air space 36 is formed between the perimeter water seal 44b, the perimeter air seal 43b, the side jamb 17 and the side jamb edge 38 of the masonry wall W similar to head portion of the air space 28 (see FIG. 5). The interior cover 17c is designed to provide the optional interior jamb finish and can alternatively be connected to the jamb air seal member 17b with other means of attachment instead of the snap-on feature as shown.

The side perimeter air seal 43b is preferably comprised of a curable caulking placed in the field between the jamb air seal member 17b and the masonry jamb edge 38. The side perimeter water seal 44a preferably comprises foam tape shop installed on the perimeter jamb frame 17 and is placed between the structural jamb member 17a and the masonry jamb edge 38 is similar to the other perimeter water seals at the other perimeter frame elements. Various shapes for the perimeter jamb member 17a and the jamb air seal member 17b and various connection methods can be contemplated that form sealing surfaces and/or alternative tortuous paths.

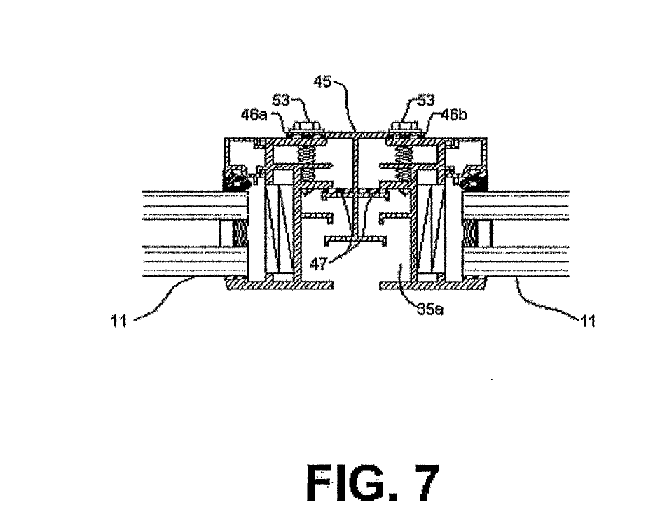

FIG. 7 shows a typical fragmentary cross-section of one embodiment of the intermediate vertical panel joint taken along line 7-7 of FIG. 2 or FIG. 3. The vertical or protruding joint member 45 with first and second intermediate air seals 46a & 46b is preferably shop installed. Intermediate water seals 47 are preferably comprised of a foam tape preferably shop installed on protruding joint member 45. Intermediate fasteners 53 secure the vertical joint member 45 to the panel assembly 11. Intermediate outer airloop 35a is similar in shape and function to the side segment of the outer airloop 35 shown on FIG. 7.

FIG. 8 shows a typical fragmentary cross-section of another embodiment of a perimeter jamb 18 taken along line 8-8 of FIG. 2. The descriptions and functional explanations are similar to FIG. 6 except that the perimeter jamb frame 18 is an alternative single member rather than the three parts of a perimeter jamb member 17 shown in FIG. 6.

In the above explanations, the ends of the vertical members 17a, 17b, 17c, 18 and 45 must be notched to allow passage of the perimeter sill frame 15 and the perimeter head frame 16. As shown in FIGS. 4-8 and FIGS. 11a-11d, to complete the perimeter air seal, the following seal connections must be accomplished:

1. connecting air seals 43a to 43c along the end profile of the perimeter sill member 15a;

2. connecting air seals 43c to 41 along the end profile of the jamb air seal member 17b;

3. connecting air seals 43c to 43b at the corner; and

4. connecting air seals 46a to 46b at the ends of the vertical joint member 45.

FIG. 9 shows an isometric and exploded view of perimeter head and sill members 15a & 16, and two jamb perimeter members 17a, preferably shop fabricated, in an exploded position prior to field assembling and attachment to the building wall (e.g., see FIGS. 4, 5, 6, and 7). To facilitate the field erection, the perimeter head frame 16 and the perimeter sill member 15a are preferably shop attached with end positioning clips 48 using set screws 51 at an assembling position 49. An assembling position with a representative exploded view shown in FIG. 9 prior to sliding the clips (in engaging pocket 59) and set screws 51 to the installed positions 50. The assembling position is about six inches away from the perimeter head frame 16 end and the sill member 15a end. The screw holes 50 may also be provided to secure the clips 48 in the installed positions on the head and perimeter sill members 18 and 15a.

FIG. 10 shows an isometric view of the positioning clip 48. The clip has corner notches 58 to allow the clip 48 to slide freely within the engaging pocket 59 (e.g., see FIG. 6) in the frame members 15a, 16, 17a, and 18.

FIG. 11a shows the air seal 43c connected to air seal 43a using corner air seal 43d at an end of the frame elements. Air seal 43d is preferably field applied caulking, but other sealing means may also be used. Other items shown are similar in function to that shown in FIG. 4.

FIG. 11b shows air seal 43c connected to air seal 41 by using corner air seals 41b and 41a. Comer air seal 41a is typically shop applied foam tape. Comer air seal 41b is typically field applied caulking. Other items shown are similar in function to that shown in FIG. 4.

FIG. 11c shows air seal 43c connected to air seal 43b at the corner. Air seals 43b and 43c are typically field applied caulking. Other items shown are similar to that shown in FIG. 5.

FIG. 11d shows air seal 46a connected to air seal 46b by using air seal 46c. Air seal 46c is preferably a shop applied foam tape. Other items shown are similar in function to that shown in FIG. 4.

Referring to FIGS. 1-11d, representative field erection procedures for the perimeter frames include the following steps.

Step 1: Slide the vertical jamb members 17a or 18 into engagement with the positioning clips 48.

Step 2: Place the perimeter head frame 16 with the positioning clips 48 on top of the jamb members 17a or 18 to cause clip engagement with the jamb members. At this stage, the perimeter frames are in an assembling position but not connected to the jamb members 17a or 18. Optionally, additional set screws can be applied at this stage to secure the jamb members 17a or 18 to the clips 48 for easier handling.

Step 3: Lift the assembled perimeter frame into the vision hole in the wall and adjust the head and the sill frame to the installed position using spacers or shims 60 (see FIGS. 4, 4a, and 5) as required.

Step 4: Apply the fasteners 25 and 32 to secure the head 16 and the sill 15a or 15c into the masonry wall.

Step 5: Apply curable caulking along the ends of sill frame 15a or 15c and head frame 16 to the edge surfaces of the masonry wall. It must be noted that these member ends are accessible at this stage due to the fact that the jambs 17a or 18 are away from the corner at the assembling position 49.

Step 6: Release the set screws 51 and push the jambs 17a or 18 to the corner and re-apply the set screws to the installed positions 50. At this stage, the correct frame dimensions are ensured.

Step 7: Shim the jambs 17a or 18 using shims 60 (see FIGS. 6 or 8) as required and apply the fasteners 39 to secure the jambs to the masonry wall.

Step 8: Apply field caulking to complete the water seals and air seals as previously described.

In case of a punch-out window system with a single vision panel, the panel erection procedures after the perimeter frames have been installed are stated below.

Step 1: Lift the panel 11 and tilt the panel bottom to the outside and then, engage the panel male joint spline 52 into the female joint 33 (see FIG. 5) in a tilted angle and slide the panel upwardly until the bottom clears the male lip 19 (see FIG. 4), then, straighten up the panel and drop the panel down to cause the panel bottom engagement with the male lip 19. Center and adjust the left to right position if required.

Step 2: Slide the jamb air seal members 17b into position on both sides, apply the fasteners 42 to secure 17b to 17a, and apply marriage caulking 41b along the ends of 17b to connect the air seal 43c to air seal 41. Snap on the cover 17c if required.

Step 3: Apply the panel screws 53 through 17b into the panel male joint spline 52. Optionally, the ceiling edge support angle 54 (see FIG. 5) can be secured at the same time.

In case of a window wall system or a punch-out window system with multiple vision panels, a representative set of remaining panel erection procedures can be as stated below.

Step 1: Lift the first panel 11 and tilt the panel bottom to the outside and then engage the panel male joint spline 52 into the female joint 33 (see FIG. 5) in a tilted angle and slide the panel upwardly until the bottom clears the male lip 19 (see FIG. 4), then, straighten up the panel and drop the panel down to cause the panel bottom engagement with the male lip 19. Push the panel all the way to the left to over engage with the left-side perimeter jamb frame 18 (see FIG. 2).

Step 2: Slide the vertical joint member 45 from the side into engagement with the first panel 11 and push the member 45 all the way to the left. At this stage, if there is only two panels in the masonry wall hole, the room on the right side should be enough to prevent the interference with the right-side perimeter jamb frame 18.

Step 3: Repeat Steps 1 and 2 to get all panels into the engaged positions at the top and the bottom. Then, adjust the left to right positions for all panels 11 (see FIG. 2) and the vertical joint members 45 (see FIG. 7).

Step 4: Apply the panel fasteners 53 through members 18 (see FIG. 8) and members 45 (see FIG. 7) into the panel male joint spline 52 (see FIG. 5). Optionally, the ceiling edge support angle 54 (see FIG. 5) can be secured at about the same time using fastener 53.

In case of a ribbon window system, a set of representative panel erection procedures is stated below.

Step 1: Lift the first panel and tilt the panel bottom to the outside and the engage the panel male joint spline 52 into the female joint 33 (see FIG. 5) in a tilted angle and slide the panel upwardly until the bottom clears the male lip 19 (see FIG. 4), then, straighten up the panel and drop the panel down to cause the panel bottom engagement with the male lip 19. Adjust the left to right position as required.

Step 2: Slide the vertical joint member 45 into position and apply the fasteners 53 through the installed member 45 into the panel male joint spline 52 (see FIG. 5). Optionally, the fasteners 53 can be applied after a number of panels have been placed in position and the ceiling edge support angle 54 can be secured at about the same time.

Step 3: Repeat Steps 1 and 2 till all panels are installed. If clearance room is needed for the last panel, follow the steps in the prior procedures with multiple panels.

The performance improvements mostly achieved by the invention are summarized below.

1. As explained above, perimeter seal design includes the airloop principle with separation of air seals and water restrictors using pressure equalized air spaces. Therefore, improved long-term watertightness is expected.

2. As explained in the erection procedures above, all field assembling and sealing are performed from the interior on the floor level, therefore, the invention avoids the requirement for exterior access during installation.

3. As explained above, the vision or other panels can be the same as a compatible airloop curtain-wall panel, therefore, interface problem with a curtain wall is minimized.

4. As it can be seen on FIG. 5, relative motion of support surfaces, e.g. caused by one or more inter-floor deflections, is designed to be absorbed by the joint formed by the panel male spline 52 and the female joint 33 of the top perimeter frame 16 and slidable seals are not affected by the inter-floor deflection.

Many other variations can be contemplated. For example, in a window frame system, one of the vision glass panels can be replaced with a door panel for access to the exterior patio. In another embodiment, especially for applications in areas with a high wind load and/or a large panel height, the vertical joint member 45 can be designed as a structural support member by extending either inwardly or outwardly, e.g., with a ribbed design. Thermal breaks can be added to the frame members for embodiments requiring improved thermal insulation performance.

Although the preferred embodiment of the invention has been shown and described, and some alternative embodiments also shown and/or described, changes and modifications may be made thereto without departing from the invention. Accordingly, it is intended to embrace within the invention all such changes, modifications, and alternative embodiments as fall within the spirit and scope of the appended claims.

What is claimed is:

1. A panel frame assembly for supporting at least one panel in an exterior wall separating an exterior environment from a building interior environment, said panel frame assembly comprising:
at least one panel frame capable of at least partially supporting said panel;
a panel air seal contacting said panel frame and said panel, said panel air seal in fluid contact with said interior environment;
a panel water restrictor located between said panel frame and said panel, the panel water restrictor spaced apart from said panel air seal wherein portions of said panel water restrictor, panel air seal, panel frame, and panel substantially bound a first airloop portion that is pressure equalized with said exterior environment through a first air passageway;
a first perimeter frame attached to said wall and capable of at least partially supporting said panel and said panel frame;
a wall air seal contacting said first perimeter frame and said wall, said wall air seal in fluid contact with said interior environment;
a wall water restrictor located between said first perimeter frame and said wall, the panel water restrictor spaced apart from said wall air seal wherein at least portions of said wall water restrictor, wall air seal, wall, and first perimeter frame substantially bound a perimeter air space portion that is pressure equalized with said exterior environment through a second air passageway;
a frame air seal located between said panel frame and said first perimeter frame, said frame air seal in fluid contact with said interior environment; and
a frame water restrictor located between said panel frame and said first perimeter frame, the frame water seal spaced apart from said frame air seal, wherein at least a portion of said frame air seal, said frame water seal, and said first perimeter frame form at least part of the boundaries of a second airloop portion that is pressure equalized with said exterior environment through a third air passageway.

2. The panel frame assembly of claim 1 which also comprises a removable spline retaining said panel frame substantially within said first perimeter frame wherein said spline is removable in the absence of access to said panel frame assembly from said exterior environment.

3. The panel frame assembly of claim 2 which also comprises:
a shim for spacing apart at least a portion of said first perimeter frame from said wall;
a second panel frame sealably connected to said panel and forming at least a portion of a frame assembly;
a second perimeter frame attached to a second portion of said wall wherein said second portion of said wall is located in a position substantially opposed to the portion of said wall attached to said first perimeter frame;
a jamb frame connected to said perimeter frames;
a jamb air seal located between said second panel frame and said jamb frame; and
a jamb water restrictor located between said second panel frame and said jamb frame and spaced apart from said jamb air seal, wherein said jamb air seal, said jamb water restrictor, at least one of said perimeter frames, and at least one of said panel frames bound at least part of a third airloop portion,
wherein said jamb frame and perimeter frames form at least part of a retainer assembly for supporting said frame assembly in a position within clearance dimensions and wherein said clearance dimensions allow said frame assembly to be slidably disconnected from said perimeter frames in the absence of access from said exterior environment and in the absence of detaching said perimeter frames from said wall.

4. The panel frame assembly of claim 3 wherein said clearance dimension allows said panel to be moved no more than about ¾ inch in any direction prior to removal of said panel from said panel frame assembly and also allow relative motion of between said perimeter frame and panel frame of at least about ¼ inch.

5. The panel frame assembly of claim 4 which also comprises an end air seal connecting at least one frame air seal with said jamb air seal.

6. The panel frame assembly of claim 5 wherein said wall water restrictor is a tortuous path through said second air passageway.

7. The panel frame assembly of claim 5 wherein said wall water restrictor is a discontinuous water seal.

8. The panel frame assembly of claim 6 wherein said frame water restrictor is a tortuous path through said third air passageway.

9. The panel frame assembly of claim 8 wherein said panel water restrictor is a water seal.

10. The panel frame assembly of claim 9 which also comprises a plurality of first airloop portions, second airloop portions and third airloop portions, with a majority of said airloop portions each having an air passageway for equalizing pressure within the airloop portion and the exterior environment.

11. A frame assembly for supporting one of more isolated vision panels in a substantially fixed wall location of a building, said frame assembly comprising:
four panel frame elements sealably connected to a surface of a panel, together forming at least a portion of a framed panel subassembly;
a perimeter frame element fastened to a wall using a fastener and sealably connected proximate to said framed panel subassembly; and
a substantially vertical frame element attached to said perimeter frame element, said vertical frame element sealably connected to at least a portion of at least one of said panel frame elements wherein said perimeter frame element and said vertical frame element form a retainer for supporting said framed panel subassembly in a substantially fixed position within clearance dimensions,
wherein said clearance dimensions support said framed panel subassembly in a substantially fixed location and also allow said framed panel subassembly to be slidably disconnected from said frame assembly from inside said building in the absence of unattaching said perimeter frame element from said building surface and in the absence of unfastening said vertical protrusion frame element from said perimeter frame.

12. The window frame assembly of claim 11 which also comprises a removable spline between said perimeter frame element and said framed panel subassembly wherein said fastener is a threaded fastener and said clearance dimensions are no more than about ¾ inch.

13. The window frame assembly of claim 12 wherein also said clearance dimensions allow relative motion of at least about ¼ inch between said perimeter frame element and said framed panel subassembly.

14. A panel frame assembly for supporting a vision panel from a surface or a building, said panel frame assembly comprising:
four panel frame elements sealably connected to a surface of said panel, said panel frame elements and said panel comprising a framed panel subassembly; and
a first perimeter frame element sealably attached to said surface of said building,
wherein said framed panel subassembly and said perimeter frame element form at least a portion of the boundaries of at least two airloops and wherein said framed panel subassembly is retained at least in part by a removable spline in a recess that allows said framed panel subassembly to be installed and removed without access from the exterior of said building and allows relative motion between said first perimeter frame element and said four panel frame elements of at least about ¼ inch.

15. The panel frame assembly of claim 14 which also comprises a second perimeter frame element sealably connected to said framed window subassembly and fastened to a building surface.

16. The panel frame assembly of claim 15 which also comprises an air passageway from an air space bounded at least in part by said first perimeter frame element and said building surface, wherein said air space has a volume of at least about 1 cubic inch per linear foot of said perimeter frame elements.

17. The panel frame assembly of claim 15 which also comprises a window water restrictor and a window air seal located between one of said panel frame elements and said panel, wherein said window water seal, said window air seal, said panel frame element and said window pane comprise at least in part the boundaries of a third airloop.

18. The panel frame assembly of claim 17 which also comprises means for draining water from said third airloop.

19. A process for installing an enhanced panel assembly to a building comprising:
attaching and corner sealing a perimeter frame assembly to said building;
placing a framed window panel subassembly substantially within said perimeter frame member; and
installing a spline member for retaining said framed window panel subassembly, said installation substantially accomplished from within said building,
wherein said spline is placed in a recess that allows relative motion between said perimeter frame assembly and said framed window panel subassembly.

20. A window system for supporting at least one window panel from a load bearing wall of a building, said window system comprising:
at least one perimeter frame element attached to said load-bearing wall wherein a portion of said perimeter frame element forms a portion of the boundary of an air space that is also at least partially bounded by said load-bearing wall and wherein said air space includes a passageway that allows said air space to be pressure equalized with the environment near the exterior of said building;
a perimeter water-flow restrictor restricting fluid flow between said perimeter frame element and said load bearing wall located so as to be fluidly communicating with air in an environment near an exterior surface of said building;
a perimeter air-seal restricting fluid flow between said perimeter frame element and said load bearing wall, said air-seal located so that one portion is be in fluid communication with air from an interior space within said building and another portion is in fluid communication with said air in an environment near an exterior surface of said building;
at least one panel frame element sealably attached to said window panel wherein a portion of said panel frame element forms at least a portion of the boundary of an inner airloop space that is also generally bounded by said window panel wherein said inner airloop includes a passageway that allows said inner airloop space to be pressure equalized with the environment near the exterior of said building;
a panel water-flow restrictor restricting fluid flow between said panel frame element and said window panel located so as to be fluidly communicating with environmental air near the exterior of said building and a inner airloop passageway capable of allowing pressure equalization between said inner airloop and the exterior of said building;
a panel air-seal restricting fluid flow between said panel frame element and said window panel located so as to be fluidly communicating with an interior space within said building, wherein said panel frame element is connected to said perimeter frame element and a portion of said perimeter frame element and said panel frame element form a portion of the boundary of an outer airloop that is also generally bounded by said frame elements, wherein said outer airloop includes a passageway that allows said outer airloop space to be pressure equalized with the environment near the exterior of said building;
an outer airloop water-flow restrictor restricting fluid flow between said panel frame element and said perimeter frame located so as to be fluidly communicating with the environment near the exterior of said building; and
an outer airloop air-seal restricting fluid flow between said panel frame element and said perimeter frame located so as to be fluidly communicating with an interior space within said building, and a passageway allowing pressure equalization between said outer airloop and the exterior of said building,
wherein a spline at least partially retained said panel frame element within a recess that allows relative motion between said panel and said perimeter frame element within the range of from about 0.25 to 1.27 centimeters.

21. The process of installing a window in a masonry wall comprising:
a. sliding a vertical jamb member into engagement with a positioning clip;
b. assembling a perimeter head frame and a perimeter sill frame with said positioning clip on each end of a jamb member to cause clip engagement of said perimeter frames with said jamb member in an assembled position;
c. lifting the assembled and secured perimeter frame into an opening in said masonry wall and adjusting said assembled head and the sill frame to the installed position;
d. installing head and sill frame air seals;
e. securing said head and sill perimeter frames to said masonry wall using fasteners;
f. applying caulking along the ends of said sill frame and head frame to seal the edge surfaces of said masonry wall;
g. moving said vertical jambs to the masonry corners and securing said vertical jambs in an installed position; and
h. installing vertical jamb air seals and fastening said vertical jambs to said masonry wall.
